(19) United States
(12) Patent Application Publication
(10) Pub. No.: US 2003/0142955 A1
(43) Pub. Date: Jul. 31, 2003

(54) Apparatus for correcting an abnormality of video signal of a video system, its method, and recording medium storing the method

(76) Inventors: Aki Hashizume, Kodaira (JP); Hirotada Ueda, Kokubunji (JP); Toshiya Sakai, Sayama (JP); Makoto Kutsuwada, Hachioji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/322,603

(22) Filed: Dec. 19, 2002

Related U.S. Application Data
(63) Continuation-in-part of application No. 09/150,235, filed on Sep. 10, 1998.

(30) Foreign Application Priority Data
Sep. 12, 1997 (JP) 09-249086
Sep. 19, 1997 (JP) 09-254488

(51) Int. Cl. H04N 5/76; G11B 27/00

(52) U.S. Cl. 386/52; 386/113; 348/700

(57) ABSTRACT

A video system for reproducing, recording and editing moving images, an abnormality state of the video system or images is automatically detected from the reproduced images, the reproduced images detected as in the abnormality state is recorded as a still image which is displayed on a display screen.

The present application is a Continuation-In-Part of application Ser. No. 09/150,235, filed Sep. 10, 1998, entitled “AN APPARATUS FOR DETECTING ABNORMALITY OF A VIDEO SYSTEM, ITS METHOD, AND RECORDING MEDIUM STORING THE METHOD”, by Aki HASHIZUME, the contents of which are incorporated herein by reference.

### BACKGROUND OF THE INVENTION

1. Field of the Invention

The present invention relates to an apparatus for detecting abnormality of a video system which records, reproduces, and edits video data such as television broadcast program video sources and video images.

2. Description of the Related Art

Television broadcast program generating facilities and video program generating facilities are now being provided with highly sophisticated functions by computers which control various functions. In generating a program, a moving image editing system and an image editing method suitable for the moving image editing system are used, the moving image editing system being constituted of a video recording/reproducing apparatus capable of digitally processing audio and video data having a randomly accessible hard disk as a recording medium for storing data.

In the moving image editing system having a hard disk as the recording medium, various functions are controlled by a computer. With the moving image editing method, image information of moving images made of audio and video data is edited through software by displaying windows on a display connected to the computer. The windows contain necessary editing control information such as operation buttons and editing data display boxes for controlling the moving images to be edited and the video system itself.

A general video system using a computer will be described with reference to FIGS. 2, 3, 4 and 7. FIG. 2 is a block diagram showing an example of the structure of a conventional video system. In this drawing, a broad arrow indicates a video signal line, and a narrow arrow indicates a control signal line. In FIG. 2, reference numeral 201 represents a video reproducing apparatus, reference numeral 202 represents a first monitor, reference numeral 203 represents a control computer, reference numeral 204 represents a display, reference numeral 205 represents a keyboard, reference numeral 206 represents a mouse, reference numeral 207 represents a video recording/reproducing apparatus, reference numeral 208 represents a video source such as a video cassette tape, reference numeral 209 represents a second monitor, reference numeral 210 represents a video recording medium such as a magnetic disk, reference numeral 211 represents a log file unit, reference numeral 200 represents a video signal cable, and reference numeral 212 represents an output video signal. The control computer 203 is connected to the video reproducing apparatus 201, video recording/reproducing apparatus 207, log file unit 211, display 204, keyboard 205, and mouse 205. The video source 208 is connected to the video reproducing apparatus 201, the first monitor 202 is connected to the video reproducing apparatus 201 via the video signal cable 200, the video recording medium 210 is connected to the video recording/reproducing apparatus 207, and the second monitor 209 is connected to the video recording/reproducing apparatus 207 via the video signal cable 200. The video reproducing apparatus 201 and video recording/reproducing apparatus 207 are connected by the video signal cable 200.

These devices other than the video source 208, video reproducing apparatus 201, and first monitor 202 are in some cases configured as an integrated video editing system. These devices may be configured to be connected via interface to the control computer 203. An output video signal 212 from the video recording/reproducing apparatus 210 is supplied to a broadcasting apparatus (not shown) for on-air or supplied to another video system.

The control computer 203 shown in FIG. 2 controls the operation of the video system by using software. The video reproducing apparatus 201 reproduces images from the video source 208. An image reproduced by the video reproducing apparatus 201 is supplied to the first monitor 202 and video recording/reproducing apparatus 207. The first monitor 202 displays the reproduced image. The video recording/reproducing apparatus 207 records the input image in the video recording medium 210. The video recording/reproducing apparatus 207 reproduces images recorded in the video recording medium 210 and sends them to the second monitor 209 which displays the images. The control computer 203 has as its peripheral devices the display 204, keyboard 205, mouse 206, and log file unit 211. The control computer 203 controls the video system by displaying an operation/control screen on the display 204 by using graphical user interface (hereinafter called GUI) which substitutes for the functions of push buttons and the like. An operator uses either the keyboard 205 or mouse 206 to enter an operation/control instruction on the operation/control screen.

FIG. 3 shows an example of the operation/control screen displayed on the display 204 by using GUI. Reference numeral 30 represents an operation/control screen, reference numerals 302-1, 302-2, and 302-3 represent windows such as a message window and a dialog window displayed on the operation/control screen 30, reference numeral 301 represents a push button displayed in the window 302-1 as a graphic component. In the example shown in FIG. 3, the dialog box window 302-3 is displayed in front of the message window 302-2. The message window 302-3 may be displayed in front of the dialog box window 302-3 by moving a cursor of the mouse 206 into an area of the message window 302-2 and clicking the mouse 206.

Moving the window to the front or rear or to another position is a feature of a message window. Clicking is an operation of, for example, pushing a predetermined one of push buttons of the mouse 206 after a pointer such as a cursor is placed on the push button 301 on the operation/control screen 30 displayed on the display 204 by using GUI. The operation/control screen displayed on the display and operated upon by using a pointing device 206 such as a mouse and a track ball, is called a message window. A specific key of the keyboard 205 is assigned for the push button operation. Therefore, the clicking operation can be performed also by depressing this specific key. The operator uses the video system by using either the pointing device or the keyboard 205.

The control computer 203 controls the video reproducing apparatus 201 and video recording/reproducing apparatus 207 by connecting them with a network control cable (e.g., RS-422A standard interface).

FIG. 7 shows an example of a message window used for displaying a message regarding a current control state of the video system. Reference numeral 71 represents a message regarding the system state, reference numeral 72 represents a schematic graph showing a progress state of the system, reference numeral 73 represents a button for cancelling an instruction, and reference numeral 70 represents a message window on which a message regarding the system state is displayed. This message window is displayed on the operation/control screen 30.

FIG. 4 shows an example of a message window for displaying a message regarding an abnormality state. Reference numeral 401 represents a message (error message) regarding an abnormality state, reference numeral 402 represents an abnormality display mark for drawing an operator's attention or for indicating a degree of abnormality, and reference numeral 40 represents the message window or an error message screen for displaying the message 401 regarding the abnormality state. This message window is also displayed on the operation/control screen 30. Reference numeral 403 represents a push button which is pushed to close the error message screen 40 after the message 401 is checked.

When the contents of the video source 208 (e.g., video tape) are to be dubbed to the video recording medium 210 (e.g., hard disk), an operator performs the following works.

First, the video source 208 is made reproducible by the video reproducing apparatus 201. The video recording medium 210 is made recordable by the video recording/reproducing apparatus 207. A dubbing start push button on the message window, for example the operation/control screen 30 (FIG. 3) displayed on the display 204 is clicked to start dubbing.

In order to allow the operator to check whether the dubbing is being performed normally, the window 40 (FIG. 4) with the error message 401 regarding the abnormality state is displayed in a pop-up manner to inform the abnormality state to the operator. For example, if the dubbing is not performed in a predetermined time after the control computer 203 instructs a dubbing operation from the video source 208 to the video recording medium 207, it is judged to be the abnormality state and the error message 401 “CANNOT RECORD” is displayed.

The control computer 203 not only displays the monitored results on the operation/control screen 30, but also writes the monitored results in the log file unit 211 for use them as the past record. The log file unit 211 stores a control instruction issued by the control computer 203, all contents of the communication such as responses from the video reproducing apparatus 201 and video recording/reproducing apparatus 207, and time and date when an error occurs, in the order of error occurrence and in the text format. It is not necessary for an operator to always look at the operation/control screen 30 in order to monitor the video system state. Specifically, even if the operator moves from the video system to another site, the operator can confirm the contents of the log file unit 211 later to check the video system state while the operator moved to the other site. For example, even if the error message screen 40 on the operation/control screen 30 of the first monitor 202 is displaying the error message “CANNOT RECORD” when the operator returns to the video system, the operator cannot know at what time the recording became unable because the operator did not look at the reproduced images on the first monitor 202. However, the log file unit 211 stores information on when the instruction issued by the control computer 203 was acknowledged normally and on when the abnormality state began. The operator can therefore know when the abnormality state began. This confirmation by the operator can be performed as desired in order to prevent any miss of checking an abnormality of a control state while the operator is at the video system.

In this video system, no dubbing error concerning picture quality is recorded therein. Accordingly, if it is necessary to check the picture quality of the recorded moving images, the operator must watch the whole moving images by replaying the recording medium by video recording/reproducing apparatus. The operator must also replay the recording medium and watch the reproduced video image in order to check the start point of the necessary re-recording operation, when there arise the troubles such as an incomplete dubbing due to excess of video data amount over the capacity of recording medium, and an unexpected disconnection of the signal cable. In most cases, the re-recording of the moving images must be made from the start thereof.

If the dubbing operation is completed normally, the operator reproduces sequentially or fast-forward the images of the video recording medium 210 on the second monitor to visually confirm whether the images were not disturbed by noises or the like, and check the reproduction state of the images and the record state thereof.

An example of a computer aided video system shown in FIG. 2 is disclosed in “Avid News Cutter 3.0 User's Guide, August 1994, Chapter 3”, pages 31-32, 35, 49, 51-54, 102, Chapter 5, pages 105, 349. This document discloses that an error event occurred during the recording/reproducing operation is stored in a message text format and it can be later output as a log. This document also describes setting an IN point or an editing start point and an OUT point or an editing end point. This document does not disclose, however, recording images with an error event and displaying these images. With the conventional method for monitoring the control state of a video system, the control state is displayed on the screen and an instruction executed by the video system is stored as a past record. Therefore, it is not necessary for an operator to always monitor the video system, and the operator can check the recorded contents whenever the operator wishes. The work amount of the operator can therefore be reduced.

However, the stored record contents are only text information of an instruction the control computer issued to each device and a response from the device. Therefore, the image quality including the state of reproduced images and the abnormality state of recorded images such as image disturbance by noises, lost colors, and synchronization fluctuation, cannot be checked unless the operator actually looks at the replayed images from the beginning to the last.

If there is an abnormality to be caused by external factors of the video system, such as disconnection of a video signal cable, video signals cannot be recorded correctly so that discrimination between abnormality states is difficult. Because of these problems, in order to check whether the images were recorded correctly, the operator is required to actually replay the images and visually confirm them. It takes therefore a long time for the operator to inspect the control state of the video system, and at the worst some errors are failed to locate, resulting in a serious broadcasting accident. Still further, if a subliminal image is inserted, this image cannot be identified by an operator at an ordinary replay speed.

### SUMMARY OF THE INVENTION

The invention provides an apparatus for detecting abnormality of a video system for reproducing, recording and editing moving images capable of automatically detecting an abnormality state of the video system or images in accordance with the reproduced images and recording the reproduced images detected as in the abnormality state and displaying the images on a display screen, and provides a use method for the video system. The invention also provides an editing system and its use method used with such a video system, capable of easily setting and changing editing positions.

In the apparatus and method of this invention, an abnormality state of images or the video system is detected from moving images reproduced from a video recording medium, the image detected as in the abnormality state is stored as a still image in a storage device, and the still image detected as in the abnormal ity state is read from the storage device and displayed on a display screen.

In a moving image editing system and its editing applied this invention, it is possible to set variables of three variable items including an IN point representative of an editing start position of the moving images, an OUT point representative of an editing end position, and an interval between the editing start point and the editing end point. If the set value of the variable is changed, a fixed variable item whose set value is maintained unchanged, among the variable items whose set values are not changed, is designated so that the value of a remaining variable item can be automatically calculated and set again.

A computer program product of the invention provides a recording medium storing program code means embodying sequences of detecting abnormality of the video system or editing method in the computer readable format.

According to one aspect of the present invention, a control computer monitors the recording/reproducing state of images through image recognition to automatically detect a change point of scenes or an abnormality state of images. A still image of the moving image detected as in the abnormality state is acquired and displayed on the screen of a display, and is stored as a log file.

As a video signal is supplied to the control computer, it monitors the recording/reproducing state of images, and a change point of scenes or an abnormality state of images is detected by using software. The detected image data is displayed on the screen of a display and stored in a storage device.

An operator can check an abnormality of the recording/reproducing state of actual moving images by searching from a series of still images.

According to another aspect of the present invention, means is provided for instructing to select either the item whose value is automatically set or the item whose set editing point value is maintained unchanged and is not automatically set. By utilizing this means, a moving image editing method can be provided which can efficiently set editing points.

### BRIEF DESCRIPTION OF THE DRAWINGS

FIG. 1 is a diagram showing an example of a log image display window of an apparatus according to an embodiment of the invention.

FIG. 2 is a block diagram showing an example of the structure of a video editing system.

FIG. 3 is a diagram illustrating an example of operations to be executed by the video editing system using GUI.

FIG. 4 is a diagram showing an example of an error message window.

FIG. 5 is a flow chart illustrating software for monitoring the video system of the embodiment of this invention.

FIG. 6 is a diagram illustrating examples of operations to be executed by the embodiment using GUI of this invention.

FIG. 7 is a diagram showing an example of a message window for displaying a message regarding a current state of the video, system.

FIG. 8 is a block diagram showing an example of the structure of a video editing system according to an embodiment of the invention.

FIG. 9 is a diagram showing another example of an error message window of the embodiment of this invention.

FIG. 10 is a diagram showing an example of an operation panel window displayed on a display of a moving image editing system.

FIG. 11 is a flow chart illustrating a general sequence of setting editing points.

FIG. 12 is a diagram illustrating a priority order of editing point setting items.

FIG. 13 is a diagram showing an example of an operation panel screen displayed on a display of a moving image editing system using a moving image editing method according to an embodiment of the invention.

FIG. 14 is a flow chart illustrating the operation of setting editing points by a moving image editing method according to an embodiment of the invention.

### DETAILED DESCRIPTION OF THE PREFERRED EMBODIMENTS

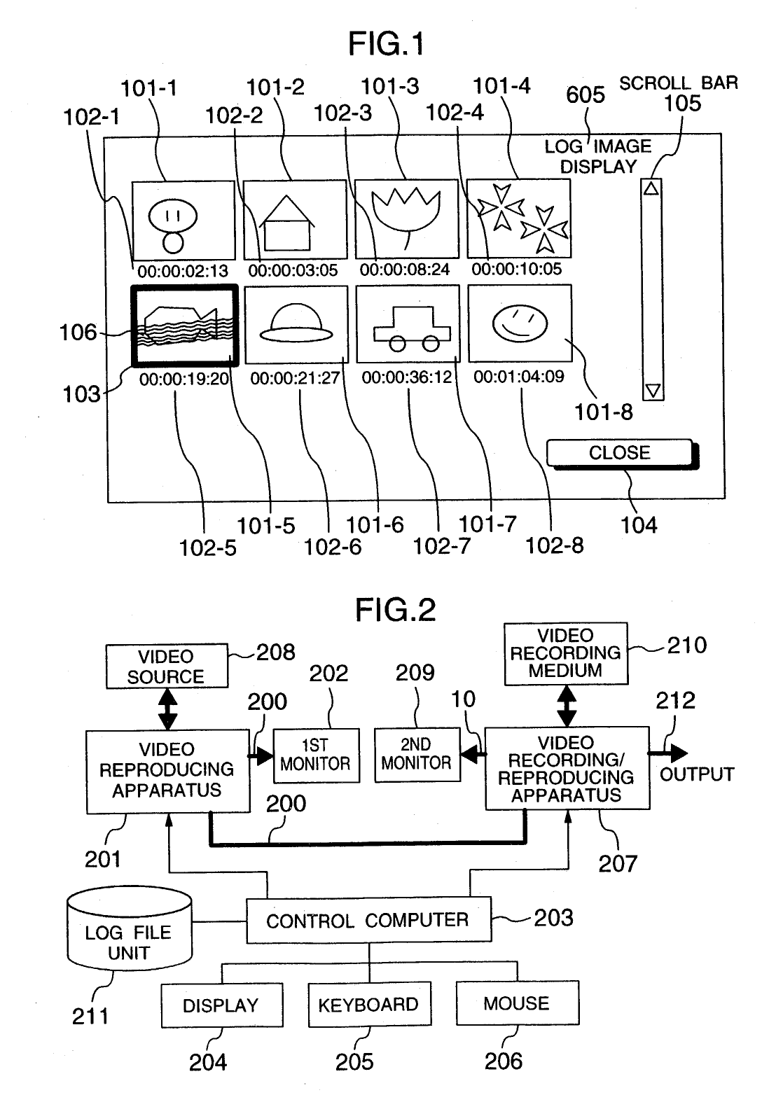

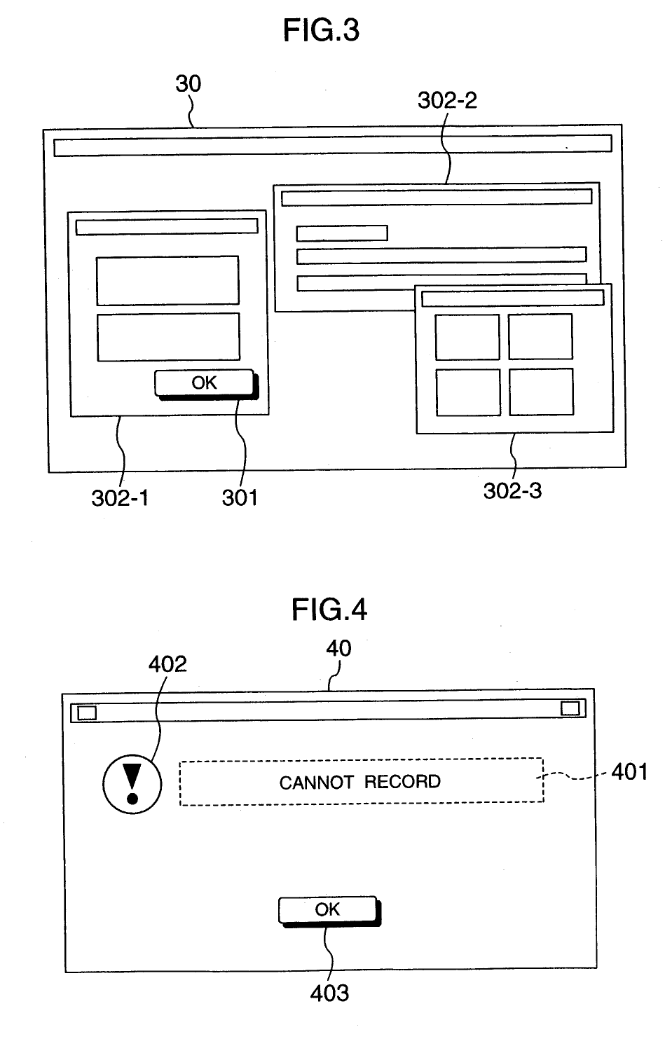

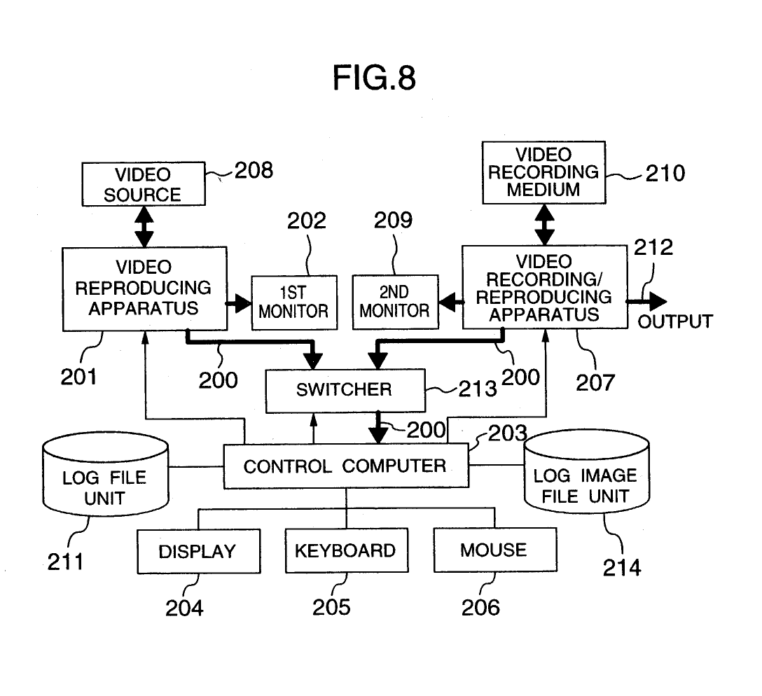

An embodiment of the invention will be described with reference to FIGS. 1, 4, 5, 6, 8, and 9. FIG. 8 is a block diagram showing an example of a video editing system embodying the invention. In FIG. 8, reference numeral 213 represents a switcher and reference numeral 214 represents a log image file unit. Other devices are represented by reference numerals identical to those of the conventional structure shown in FIG. 2. A control computer 203 is connected to a video reproducing apparatus 201, a video recording/reproducing apparatus 207, the switcher 213, a log file unit 211, the log image file unit 214, a display 204, a keyboard 205, and a mouse 206. A video source 208 is connected to the video reproducing apparatus 201 which is connected via video signal cables 10 to a first monitor 202 and the switcher 213. A video recording medium 210 is connected to the video recording/reproducing apparatus 207 which is connected video signal cables 10 to a second monitor 209 and the switcher 213. The switcher 213 is connected via a network control cable and a video signal cable 200 to the control computer 203.

Another embodiment according to the present invention will be explained below by referring to FIGS. 15, 16 and 17. In this embodiment, aforementioned log images of the image disturbance and subliminal image are recorded, the recorded log image is displayed, and then the image recorded by the video recording/reproducing apparatus 207 is restored.

FIG. 15 shows a block diagram of the structure of this embodiment, wherein 201-1, 201-2, . . . , 201-n are video reproducing apparatus, 202-1, 202-2, . . . , 202-n are first monitor displays, and 208-1, 208-2, . . . , 208-n are video sources. These devices are mutually parallel to each other and connected to the switcher 213 and the control computer 203. The reference numerals which are the same as those in FIG. 8 are the same elements.

Each of the reproduced video signals from the video reproducing apparatus 201-1, 201-2, . . . , 201-n is input to the switcher 213 via the video signal cable 200. The switcher 213 sends the input video signal to the video recording/reproducing apparatus 207. The video recording/reproducing apparatus 207 records the input video signal in the video recording medium 210. The switcher 213 may receive one or a plurality of video signals from a plurality of the video reproducing apparatus 201-1, 201-2, . . . , 201-n at the same time, and the switcher 213 may select and output one or more video signals. The video recording/reproducing apparatus 207 may also process one or more video signals.

The operation of this embodiment shown in the block diagram of FIG. 15 will be explained by taking a case that it is decided there is a problem in the video image recorded in the video recording medium 210. This embodiment can cope with the problem of the video image more flexibly than the embodiment shown in FIG. 8.

For example, there is an abnormal case that a video signal input to the video recording/reproducing apparatus 207 via the switcher 213 causes only blue image over the screen or a noisy image due to some troubles in the video cable 200 and/or a pickup head of the video reproducing apparatus 201-2 in reproducing operation. There is also another abnormal case that the video reproducing apparatus 201-2 outputs a video signal which is out of synchronization due to a failure during the reproducing operation. When such abnormal event is detected, an aforementioned log image is recorded. The control computer 203 makes the display monitor 204 display the log image, and reports the abnormal event to an operator. The control computer 203 designates a normal video reproducing apparatus having no problem, for example 201-1 in place of the abnormal video reproducing apparatus 201-2. The control computer 203 instructs the operator to make the designated normal video reproducing apparatus 201-1 redo inputting the video signal from the video source 208.

When the video source 208 is set, the control computer 203 controls the video reproducing apparatus 201-1 and the video recording/reproducing apparatus 207 to output the same video signal, which produced an abnormal image at the video reproducing apparatus 201-2, from the normal video reproducing apparatus 201-1 afresh. The video recording/reproducing apparatus 207 records the video signal from the video reproducing apparatus 201-1 to the recording medium, and while the already recorded video signal in the medium is erased, so that the abnormal image recorded in the recording medium 210 is restored to be a normal video image.

More detail of the operation of this embodiment will be explained by referring to FIGS. 16 and 17. FIG. 16 and 17 which show flow charts for implementing the operation of this embodiment wherein the abnormal video signal is corrected.

The flow chart of FIG. 16 is explained at first. In step 1000, it is determined whether an abnormality such as noise is detected in a video signal, or not. If it is determined that no abnormality has been detected, the flow is terminated. If it is determined that an abnormality is detected, the abnormal image is displayed and the identification number of the video reproducing apparatus that reproduced the abnormal image is displayed at step 1002. The abnormal image and the identification number of the video reproducing apparatus that reproduced the abnormal image are recorded at step 1004. The video reproducing apparatus with such identification number is designated as an abnormal video reproducing apparatus, and one of the video reproducing apparatuses other than the abnormal video reproducing apparatus is selected at step 1006. A video signal including the same contents as in the abnormal video signal is output from the selected video reproducing apparatus afresh at step 1008. The video signal from the selected video reproducing apparatus is recorded in the video recording medium by overwriting it on the abnormal video signal at step 1010. Then, the flow is returned to the step 1000.

The flow chart of FIG. 17 is explained below. As compared with the flow chart of FIG. 16, the flow chart of FIG. 17 further includes a step 1001. In step 1001, it is determined whether the abnormality of the image is a subliminal image, or not, after the determination that the abnormality has been detected in step 1000. If it is determined that the abnormality is a subliminal image, the subliminal image portion is deleted at step 1003. The subliminal image portion may be deleted from the video image signal recorded by the video recording/reproducing apparatus 207. The flow is then returned to step 1000 after the step 1003. On the other hand, if it has been determined that the abnormality is not a subliminal image, the flow proceeds with step 1002 and the following steps 1004, 1006, 1008 and 1010.

As explained above, according to the embodiment shown in FIGS. 15, 16 and 17, even though an abnormal video signal is recorded due to a failure of the video cable or a pick-up head or an instability of synchronization of the video signal, such abnormality is detected and a normal video image is reproduced by rapidly restoring the video signal. Therefore, this embodiment of the present invention can contribute to an efficient operation of broadcasting in a broadcasting station and eliminating of accidents in broadcasting operation.

Referring to FIG. 8, the control computer 203 controls the operation of the video editing system by using software. Upon instruction by the control computer 203, the video reproducing apparatus 201 reproduces images from the video source 208 and sends the images to the first monitor 202 and switcher 213. The first monitor 202 displays the reproduced image. The switcher 213 sends the image input from the video reproducing apparatus 201 to the video recording/reproducing apparatus 207 which records the input image in the video recording medium 210. The video recording/reproducing apparatus 207 reproduces images recorded in the video recording medium 210 and sends them to the second monitor 209. The video recording medium 210 stores video data supplied from the video recording/reproducing apparatus 207. Upon instruction by the control computer 203, the video recording/reproducing apparatus 207 reproduces images from the video recording medium 210 and sends them to the second monitor 209 and switcher 213. The second monitor 209 displays the supplied images. Upon instruction by the control computer 203, the switcher 213 performs the following operations to switch between video signal paths:

(1) sending an image entered from the video reproducing apparatus 201 to the video recording/reproducing apparatus 207;

(2) sending an image entered from the video recording/reproducing apparatus 207 to the control computer 203; and

(3) sending an image entered from the video reproducing apparatus 201 to the control computer 203.

With this switching operations, each of the operations (1) to (3) may be executed independently or the operations (1) and (2) or the operations (1) and (3) may be executed at the same time. The video recording! reproducing apparatus 207 is realized by a video server system wherein video images are reproduced after recording thereof with a delay, for example a few seconds or more depending on the type of video server system. The control computer 203 has as its peripheral devices the display 204, keyboard 205, mouse 206, and log file unit 211. The display 204, keyboard 205, mouse 206 and log file unit 211 have the functions similar to the conventional techniques. The log image file unit 214 stores therein still images. The control computer 203 monitors an image entered from the switcher 213 by using software stored in a memory of the control computer 203 to detect a scene change point, image disturbance by noises, a presence/absence of a subliminal image and the like and store a still image added with a time code representative of the time when the change point or noises are detected, in the log image file unit 214 as video log data. The detecting software will be described later. A GUI operation/control screen is displayed on the display 204. If a log image is to be viewed, a log image display push button displayed on the GUI operation/control screen on the display 204 is clicked to pop up the top window with log images.

A method of deriving an image at a scene change point is disclosed, for example, in JP-A-8-227462 or JPA-4-111181. With this method of JP-A-111181, a scene change point is detected through image recognition by a computer. A presence-absence of a subliminal image is judged in the following manner. If an interval between adjacent change points detected by a scene change point detecting process is one frame or several frames for example, it is judged that a subliminal image is being inserted. On the other hand, if an interval between adjacent change points detected by the scene change point detecting process is extraordinarily longer than a standard value, it is judged that a connection cable is disconnected or broken.

Detecting software and circuits are provided for detecting an abnormality state such as noises in a reproduced image, a subliminal image, defective video signals, and wire disconnection of the video system. The detecting software may be configured as in the following. A correlation between a subject frame and an adjacent frame is obtained and an abnormal image state is detected in accordance with the correlation. A subject frame is divided into a plurality of regions, a histogram of image data in each region is obtained and an abnormal image state is detected in accordance with the histogram. A state of a specific signal in video signals of a subject frame is detected and an abnormal image state is detected in accordance with the detected state. If the same image continues for a predetermined time or longer, an occurrence of abnormality is judged. As described previously, if an interval between adjacent change points is shorter or longer than a predetermined standard length, an occurrence of abnormality is judged. These abnormality detecting methods are performed, for example, by using moving images reproduced from the video recording medium 210 such as a magnetic disk.

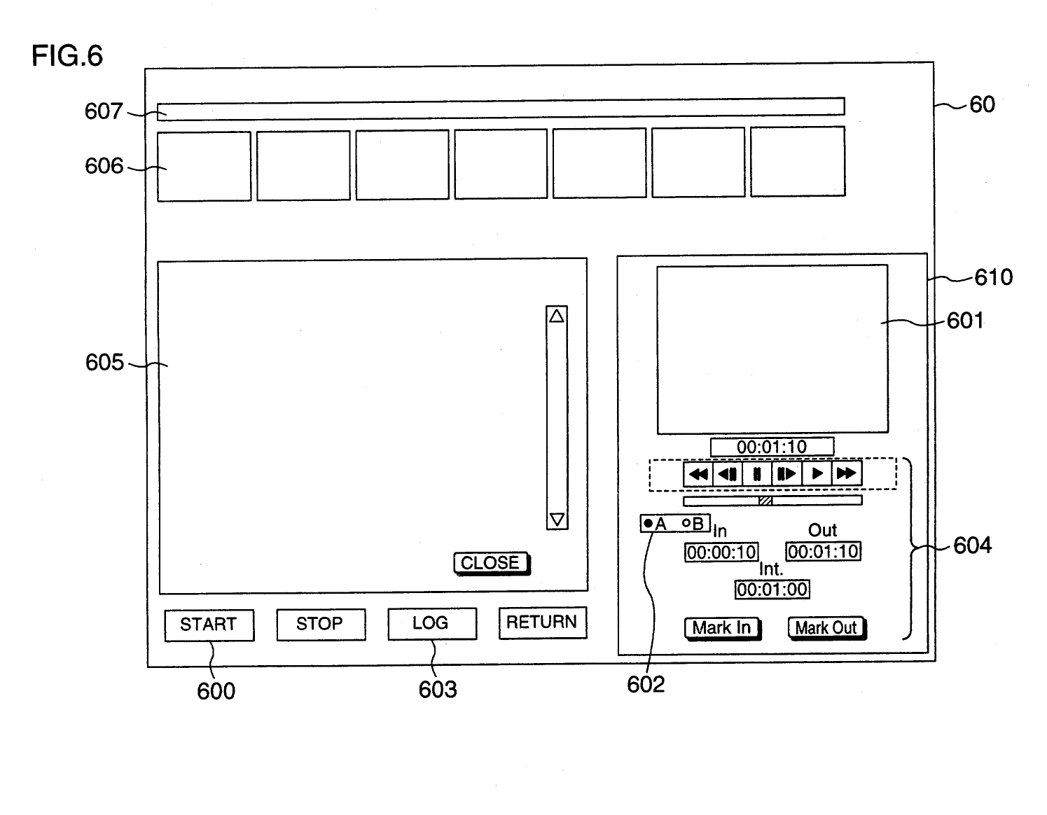

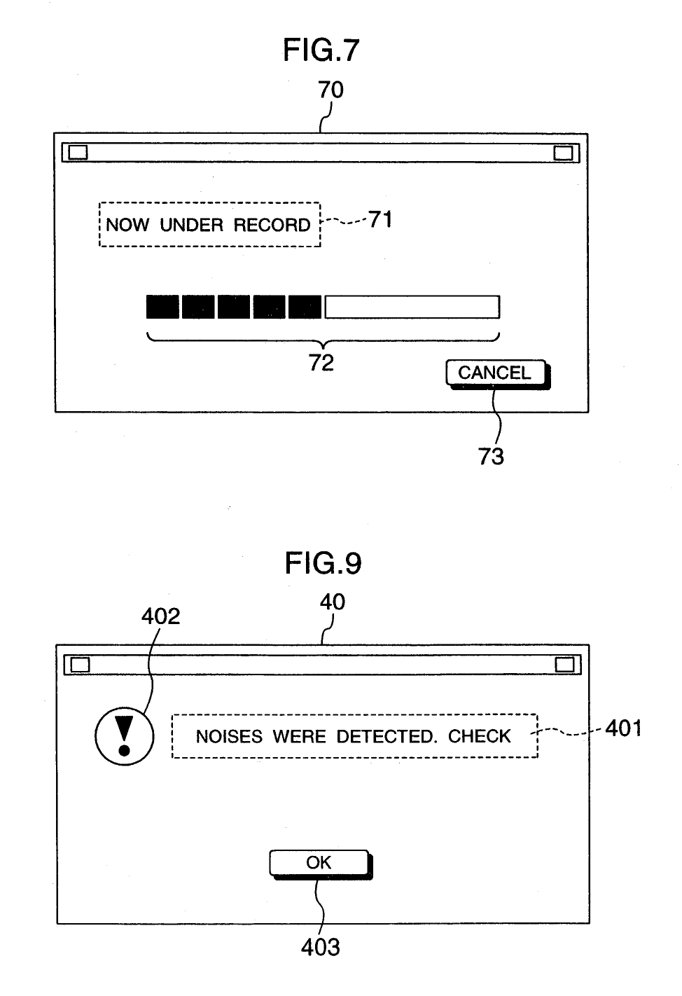

FIG. 6 shows an example of a message window displayed on the display 204. Reference numeral 60 represents an operation/control window. Reference numeral 600 represents a dubbing start push button, reference numeral 601 represents a video reproduction display area, reference numeral 602 represents a video signal switching button area, reference numeral 603 represents a log image display button for instructing to display a log image, and reference numeral 604 represents a video reproduction operation unit.

Reference numeral 610 represents an operation window for instructing to reproduce, record and edit video data. Reference numeral 605 represents a window in which a log image is displayed. Reference numeral 606 represents a series of M-icons for reproduced images currently being monitored. Reference numeral 607 represents text information indicating attributes (e.g., broadcast day and time, title and the like of images) of images to be monitored.

When the contents of the video source 208 (e.g., video tape) are to be dubbed to the video recording medium 210 (e.g., hard disk) capable of recording/reproducing video data, an operator clicks the dubbing start push button 600 on the operating control window displayed on the display 204 to thereby instruct the control computer 203 to start dubbing. The control computer 203 supplies a dubbing control instruction to the video reproducing apparatus 201 and video recording/reproducing apparatus 207. While the video recording/reproducing apparatus 207 records images in the video recording medium 210, it also reproduces the recorded images which are input via the switcher 213 to the control computer 203. The control computer 203 starts monitoring the input images.

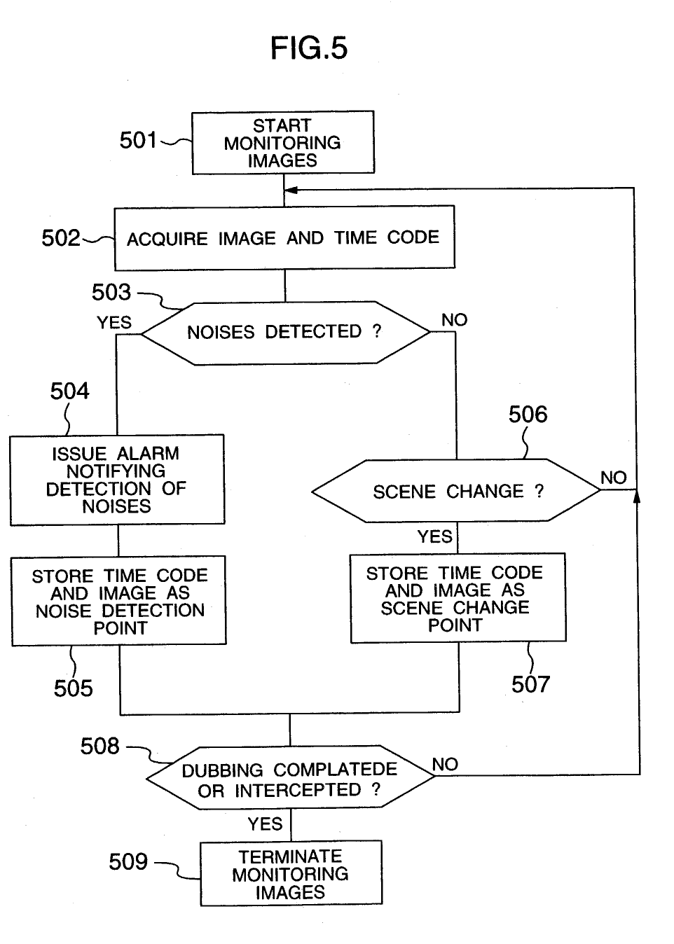

FIG. 5 is a flow chart illustrating an example of software for monitoring the video system to detect a scene change point and noises.

The control computer 203 starts monitoring 20 input images (Step 501), acquires an image and a time code of each frame (Step 502).

Next, it is checked whether noises are detected in the image. If not, the flow advances to Step 506, whereas if detected, the flow advances to Step 504 (Step 503).

At Step 506 it is checked whether the image is at the scene change point. If at the scene change point, the flow advances to Step 507, whereas if not, the flow returns to Step 502 (Step 506).

At Step 504, since noises were detected, an alarm is issued to make the operator be attended (Step 504). The noise detected image and time code are stored in the log image file unit 214 as a noise detection point (Step 505).

After Steps 505 and 507, it is checked whether all images have been processed. If not, the flow returns to Step 502, whereas if processed, the flow advances to Step 509 (Step 508).

Monitoring images are terminated at Step 509 (Step 509).

In addition to the noise detection described above, other image quality checks such as detecting a subliminal image can be performed in the manner similar to the above.

In order for the control computer 203 to issue an alarm at Step 504 and make the operator be attended, a window 40′ with a message 401′ “NOISES WERE DETECTED. CHECK” indicating an abnormality state is displayed in the operating control window as shown in FIG. 9, while alarm sounds notifying the abnormality state are generated. After confirming the message 401′, the operator depresses a push button 403′ close the alarm message window 40′. When other abnormality states occur, such as those described with the conventional techniques, the window 40 (FIG. 4) with the error message 401 (FIG. 4) notifying the abnormality state to the operator is displayed in a pop-up manner while alarm sounds are generated from the control computer 203. Not only alarm sounds but also other means such as light and vibrations sensible to the operator, or a combination thereof may be used. The type, time, and the like of the detected abnormality state may be stored in a text format not only in the log image file unit 214 but also in the log file unit 211. In this case, the abnormality state can be diagnosed more reliably in association with abnormality states of the video system before and after noises or the like are detected, by referring to the contents of the log file unit 211. An alarm for the abnormality state can be monitored remotely if the video system is connected to the Internet or LAN.

After or during the dubbing, the operator looks at the log image in order to check the quality of images recorded in the video recording medium 210. To this end, the operator clicks with the mouse 206 the log image display push button 603 in the GUI operation/control window 60 displayed on the display 204. The log image display window is displayed on the top of the GUI operation/control window 60. Log image data recorded in the log image file unit 214 is displayed in the log image display window 605.

FIG. 1 is a diagram illustrating an example of a log the message window displayed a log image display window displayed on the display 204. In FIG. 1, reference numeral 605 represents a log image display window, reference numerals 101-1, 101-2, 101-3, 101-4, 101-5, 101-6, 101-7, and 101-8 represent a series of still images stored in the log image file unit 214, and reference numerals 102-1, 102-2, 102-3, 102-4, 102-5, 102-6, 102-7, and 102-8 represent time codes “Hour: Minute: Second: Frame number” indicating the detection position information. For example, the time code 102-1 “00:00:02:13” indicates 2 seconds after the start of work and the thirteenth frame. Reference numeral 103 represents a color frame added to a noise detected image 101-5 among the series of still images 101-1, 101-2, 101-3, 101-4, 101-5, 101-6, 101-7, and 101-8. Reference numeral 104 represents a button for closing the log image display window 605, and reference numeral 105 represents 15 a scroll bar. The series of still images 101-1, . . . are displayed as many as they can be displayed within an area of the log image display window 605, in the order of detection time. In the example shown in FIG. 1, eight images are displayed at the same time on the log image display window 605. The images smaller than eight images are displayed at the same time, and the images larger than eight images can be checked by scrolling them up and down by using the scroll bar 105 so that the operator can check all the log images.

Next, the operator checks the log images displayed on the log image display window 605 and selects the log image to check the quality of the corresponding image stored in the video recording medium 210.

In order to check the image quality, the control computer 203 operates to display reproduced images on the image reproduction display area 601 in the GUI operation/control screen 60 displayed on the display 204. Images displayed on the image reproduction display area 601 are reproduced by the video reproducing apparatus 201 or video recording/reproducing apparatus 207 which is selected by the switcher 213. The video signal is switched by the operator with the switch button group 602. For example, if images from the video reproducing apparatus 201 are to be viewed, a check mark is entered in a display box “A” of the switch button group 602, whereas images from the video recording/reproducing apparatus 207 are to be viewed, a check mark is entered in a display box “B” of the switch button group 602. In the example shown in FIG. 6, since the check mark is entered in the display box “A” of the switch button group 602, images reproduced by the video reproducing apparatus 201 are displayed on the display area 601. The operator can check images displayed on the display area 601 precisely by manipulating a button group of the video reproduction operation unit 604 to “reproduce”, “feed fast forward”, “feed backward”, “stop”, or “shuttle” the images.

As described above, with the video editing system of this invention, for example, even if the operator moves to another site until the dubbing is completed and thereafter returns, a noise detected image can be known from the message window 40 or log image display window 605 on the GUI operation/control screen 60 without visually confirming all the images. When the image 101-4 emphasized by the color frame 103 shown in FIG. 1 is clicked, the control computer 203 operates to search and reproduce images from the medium selected by the switch button group 602. Therefore, the operator changes the switch button group 602 to “B” to check the images on the second monitor 209. If there are noises in images, the operator changes the switch button group 602 to “A” to view images on the first monitor 202 to check whether noises are in the video source 201. In this manner, whether noises are in the video recording medium 207 or in the video source 201 can be determined quickly. The image quality can be checked more precisely, not only from the images displayed on the image reproduction display area 601 on the display 204, but also from the images on the first and second monitors 202 and 209 linked with the selected log image via the video reproducing apparatus 201 and video recording/reproducing apparatus 207.

Other abnormality states such as a subliminal image, a cable disconnection, and a broken cable can be automatically detected in a manner similar to the noise detection. In this case, log images are added with a color frame or graphic design frame different from a color frame of a noise detected image. Since images together with time codes in an abnormality state or a state which may change to the future abnormality state can be automatically detected, the images can be checked as many times as desired, irrespective of whether or not the operator moves to another site. It is obvious that in order to discriminate between the types, urgency degrees, and operator requirements of abnormal images, the width, shape, color (white, black, transparent color, etc.), and graphic design of a frame added with a log image can be used in combination. A log image may be emphasized by other symbols and shapes different from frames.

If there is a subliminal image, the scene change point of the next image occurs quickly, whereas if a connection cable of the video system is dismounted or if images on the tape are finished, the scene change point does not occur for a long time and the log image becomes, for example, single blue color. It is therefore possible to detect an abnormality state quickly, to identify necessary images from the position of the log still image, and to provide a countermeasure for these images. A phenomenon that pictures of several lines are held into black region when a DC clamp of a video signal is lost can be detected easily with the detection software described earlier. Furthermore, phenomena such as lost color and loss of only red, and image disturbance caused by synchronization fluctuation can be detected in a similar manner so that the operator viewing the log images can know it quickly.

As described above, if the quality of recorded images is poor, it is possible to determine quickly whether the quality of the video source is poor or whether the recording/reproducing operation for the video source had any problem. If the quality of the video source is poor, the video source is replaced. If the recording/reproducing operation has any problem, this problem is dealt with.

Controlling the video system and executing the state monitoring method described above may be performed by programs stored in a recording medium. A recording medium storing process sequences of the state monitoring method may be various types of media such as a floppy disk, a compact disk, and an optical disk.

As described above, according to the present invention, a scene change point of input images and image disturbance caused by noises are automatically detected by software, and a still image at the scene change point and a still image with disturbance by noises are stored in the log file. Accordingly, those images reproduced or recorded in the past can be checked later from the log file.

The second advantage of the invention is as follows. If a connection cable of the video system is disconnected or if images on the tape are finished, the scene change point does not occur for a long time and the log image becomes, for example, single blue color. The operator can therefore detect an abnormality state quickly by watching the log image, to identify necessary images from the position of the log still image, and to provide a countermeasure for these images.

Reproduction is possible even during image recording, by using as the video recording medium 207 a recording medium (e.g., hard disk) capable of random access. In this case, without stopping the image recording operation, a desired position of the recording medium can be reproduced. Accordingly, if noises are detected even during the image recording, these images can be checked without stopping the image recording.

The third advantage of the invention is as follows. A phenomenon that pictures of several lines are held into black region when a DC clamp of video signal is lost and phenomena such as lost colors and loss of only red can be detected by the operator watching the log image. It is therefore possible to identify necessary images from the position of the log still image, and to provide a countermeasure for these images.

The fourth advantage of the invention is as follows. A subliminal image can be detected by software. It is therefore possible to identify necessary images from the position of the log still image, and to correct these images.

The fifth advantage of the invention is as follows. Synchronization fluctuation can be detected by an operator watching the log image. It is therefore possible to identify necessary images from the position of the log still image, and to again record these images.

The sixth advantage of the invention is as follows. In a non-linear video system, reproduction is possible even during image recording. It is therefore possible to check images during image recording by an operator watching the log image. Even if images are not always monitored, only those images in the abnormality state can be detected during image recording. It is therefore possible to efficiently check the work progress, image reproduction, and image recording. The apparatus of the present invention is applicable not only to the above embodiment, but also to a system which uses a magnetic tape as a recording medium 210 of the video recording/reproducing apparatus 207.

Next, the video reproduction display area 601 and video reproduction operation unit 604 shown in FIG. 6 will be described in more detail. The video reproduction display area 601 and video reproduction operation unit 604 can be used not only for image recording/reproducing but also for image editing.

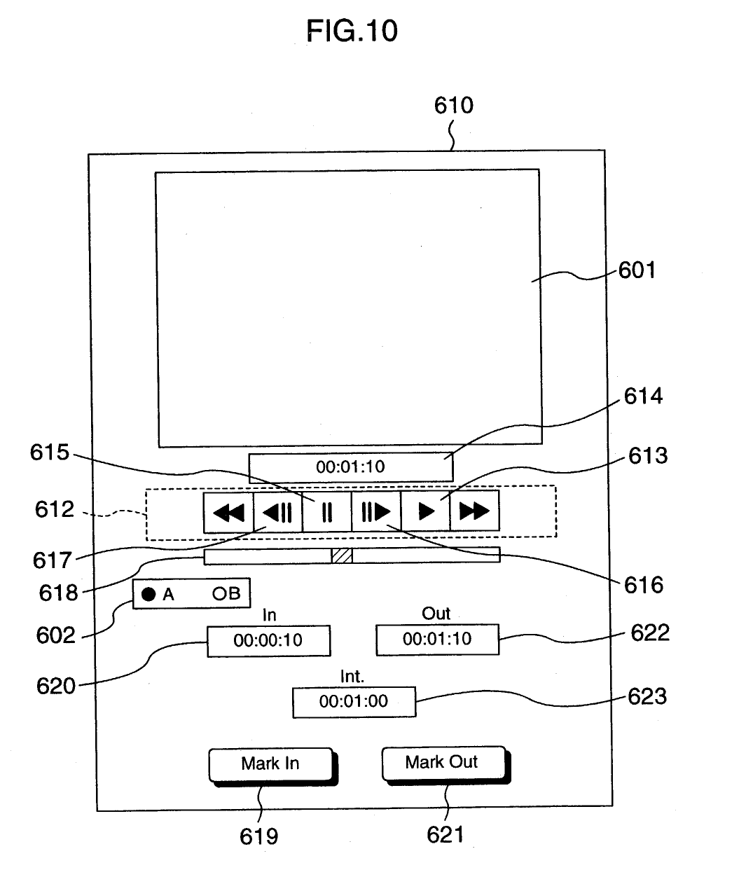

An example of a window on a computer display used for determining an editing point of moving images is shown in FIG. 10. FIG. 10 is an enlarged view of a window including the video reproduction display area 601 and video reproduction operation unit 604.

An operation panel 610 is shown in the window displayed on the display 204. Moving images reproduced by the video recording/reproducing apparatus 207 can be displayed in the image reproduction display area 601 of the operation window 610. Although an image is not shown in FIG. 10, an image is displayed during reproduction.

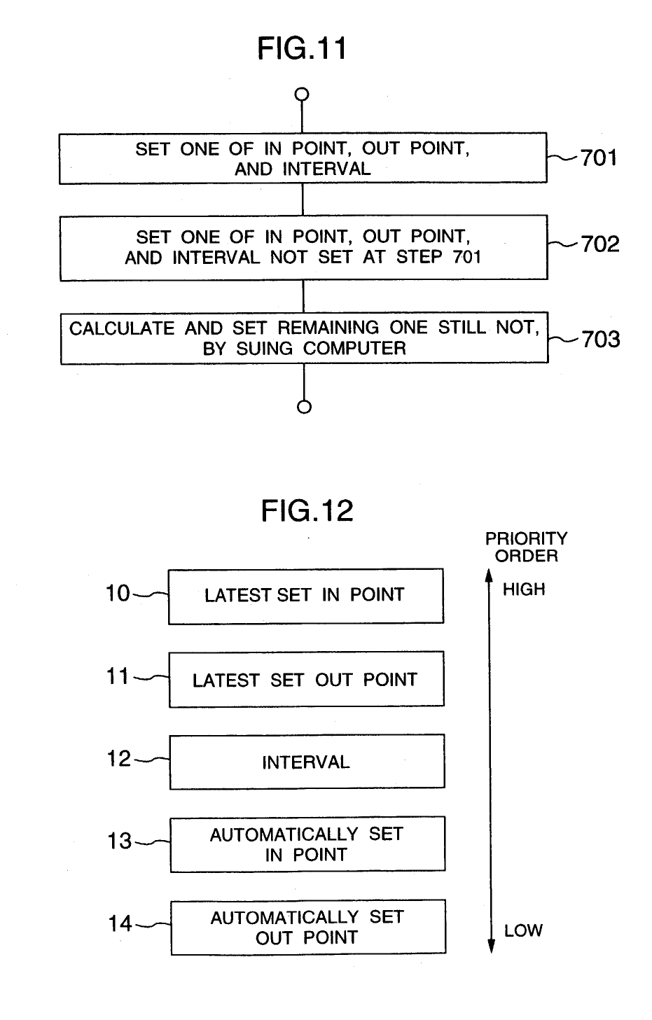

The operation button group 612 in the operation screen 610 such as a reproduction button, a feed fast forward button, and a feed backward button is used for controlling the video recording/reproducing apparatus. For example, if images recorded in the video recording! reproducing 207 are to be reproduced, a pointer is placed on a reproduction button 613 by using the mouse 206, and the mouse 206 is clicked. Then, moving images reproduced by the video recording/reproducing apparatus 207 are displayed on the image reproduction display area 601. A time code of the reproduced image stored in the recording medium is displayed on a time code display box 614. An example of processes of a method of determining an editing point of moving images will be described, with reference also to FIG. 11. There are two methods of determining an editing point of moving images.

With the first method, images reproduced by the video recording/reproducing, apparatus 207 and displayed on the image reproduction area 601 are monitored to search and determine a desired scene (position) to be edited and store the time code of the image of the desired scene. With the second method, a predetermined time code of a moving image of a desired scene is entered from the keyboard 205 (while the image corresponding to the entered time code is reproduced in some case), and the entered time code is stored.

The first method of determining an editing point of moving images, i.e., a method of searching and determining an editing point while moving images displayed on the image reproduction area 601 on the display 204 are monitored, will be described.

First, push the button 613 of the operation button group 612 of the video recording/reproducing apparatus 207 by using the mouse 206, and the mouse 206 is clicked to make the video recording/reproducing apparatus enter a reproduction state and display moving images to be edited, on the image reproduction area 601 of the operation area 601 displayed on the display 204. The reproduced moving images displayed on the image reproduction area 601 are monitored. When a desired image to be used as a start point (IN point) of the moving image to be edited is reproduced, push a pause button 615, and the mouse 206 is clicked. The reproduction is therefore stopped and the reproduced image displayed on the image reproduction area 601 enters a pause state.

In this pause state, push a frame forward reproduction button 616, a frame backward reproduction button 617, or push a shuttle function slider 618 to determine a correct IN point through frame advance or the like.

After the position of the IN point is determined, push an IN point setting button (Mark In) 619. The time code displayed in the time code display box 614 is therefore set as the IN point, and the time code in the time code display box 614 is copied to and displayed in an IN point display box 620. In this manner, an operation of setting one IN point is completed (refer to Step 701 in FIG. 11).

Next, push the reproduction button (Mark In) 619. The video recording/reproducing apparatus 207 is therefore set to the reproduction state so that the reproduced moving image is displayed on the image display area 601 of the operation area 601 displayed on the computer display 204 to thereafter set the end point (OUT point) of the moving image to be edited.

The reproduced moving images displayed on the image display area 601 are monitored. When a desired image to be used as the OUT point of the moving image to be edited is reproduced, push the pause button 615, and the mouse 206 is clicked. The reproduction is therefore stopped and the reproduced image displayed on the image display area 601 enters the pause state.

In this pause state, push to the frame forward reproduction button 616, frame backward reproduction button 617, or slide shuttle function slider 618 a correct OUT point through frame advance or the like.

After the position of the OUT point is determined, push an OUT point setting button (Mark Out) 621. The time code displayed in the time code display box 614 is therefore set as the OUT point, and the time code in the time code display box 614 is copied to and displayed in an OUT point display box 622. In this manner, an operation of setting one OUT point is completed (refer to Step 702 in FIG. 11).

After the IN point and OUT point are set by the above operations, an interval (or called a duration) between the IN and OUT points, i.e., a time duration of moving images to be edited, is automatically calculated by the editing control computer 203 and displayed in an interval display box 623. An operation of setting one interval is completed (refer to Step 703 shown in FIG. 11).

The second method of determining an editing point of moving images, i.e., a method of determining an editing point by placing the pointer on the desired display box among the IN point, OUT point, and interval display boxes to enter the time code from the keyboard 205, will be described.

For example, if the IN point is to be set, the pointer is placed on the IN point display box 320 by using the mouse 206 to enter from the keyboard 205 the time code representative of time information corresponding to the desired scene of moving images to be set as the IN point.

With this second method, the interval which can not be set directly with the first method can be entered directly from the keyboard 205.

Both the first and second methods may be used for setting editing points of moving images. For example, in setting the IN point, reproduced moving images displayed on the image display area 601 are monitored to determine a desired scene, and the time code corresponding to the image at the desired scene is set to the IN point display box 620 and stored. In setting the OUT point, the time code of a moving image corresponding to a desired scene is directly entered from the keyboard 205.

The relation between the IN and OUT points and interval of the editing points satisfies an equation “interval=OUT point−IN point”. Therefore, if the two items among the three items are determined, the remaining one item can be automatically calculated by the editing control computer 203.

Therefore, it is not necessarily required to set both the IN and OUT points in order to determine the editing points. For example, if the IN point and interval are determined, the OUT point can be calculated automatically by the computer 203.

If all the three items including the IN and OUT points and interval are set and one item is set again, one of the two items is automatically corrected by the editing control computer 203, this one item having a lower priority order as shown in FIG. 12. The priority order No. 1 is the set IN point 10, No. 2 is the set OUT point 11, No. 3 is the interval 12, No. 4 is the automatically set IN point 13, and No. 5 is the automatically set OUT point 14.

For example, assuming that in determining the editing points, the IN and OUT points are set and the computer 203 automatically sets the interval. The IN point corresponds to the latest set IN point 10, the OUT points corresponds to the latest set OUT point 11, and the interval corresponds to the interval 12. If the interval is changed to a value larger by three frames, the latest set OUT point 11 has a priority order lower 10 than that of the latest set IN point. Therefore, the OUT point is automatically changed to a value larger by three frames, without changing the presently set IN point.

In the moving image editing method described above, as one of the items is changed after the IN and OUT points and interval have already set, the item having the lower priority order is automatically changed. For example, if the IN point is changed, either the OUT point or interval is automatically changed. Which one of the items is selected depends upon the priority order if the priority order has been preset.

Since the item selection depends upon the priority order, if there is an item which is not desired to be changed, this item is required to be memorized before the item, e.g., IN point, is changed. After the item value is automatically changed, the memorized item is again entered.

If the priority order of the editing points to be changed is different from the priority order preset at the moving image editing system, the item once set is required to be entered thereafter.

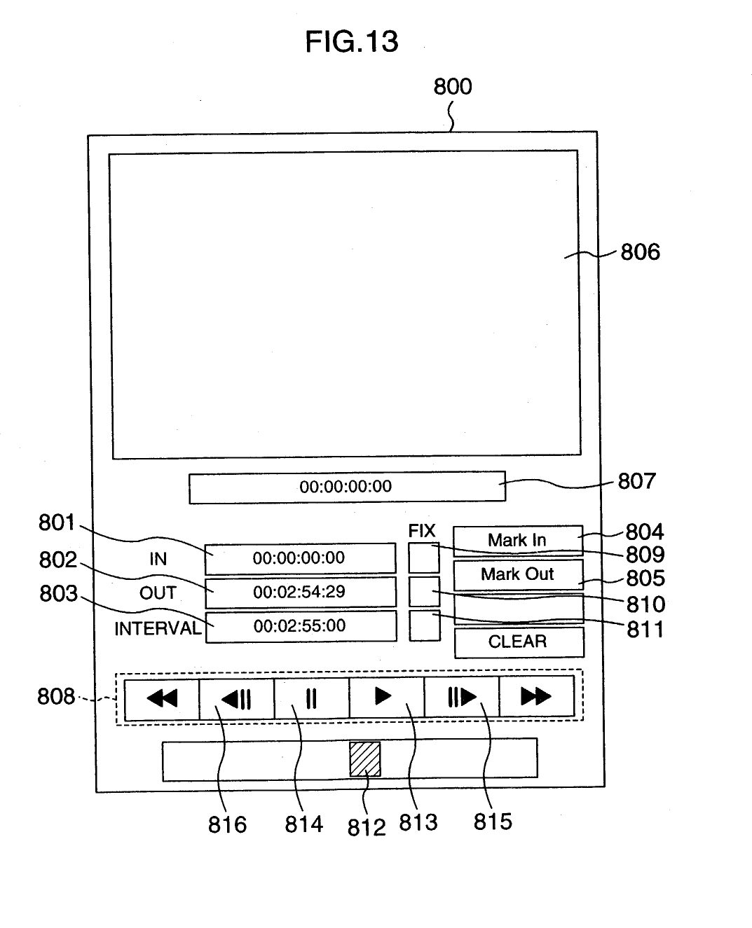

Another embodiment of a moving image editing method capable of solving the above problem and setting the editing points of moving images, will be described. Another embodiment of an editing screen displayed on the display of the moving image editing system by using the moving image editing method is illustrated in FIG. 13. An image of an operation window 800 shown in FIG. 13 is displayed in the GUI screen 60 as shown in FIG. 6.

Referring to FIG. 13, the operation window 800 used for determining an editing point of moving images is shown in the screen of the computer display 204. Moving images reproduced by the video recording/reproducing apparatus 207 can be monitored in a display area 806 of the operation window 800. Although an image is not shown in FIG. 13, an image is displayed during reproduction.

Disposed on the operation window 800 are: an 20 operation button group 808 such as a reproduction button, a feed fast forward button, and a pause button used for controlling the video recording/reproducing apparatus 207; a time code display box 807 for displaying a time code on the recording medium corresponding to the image reproduced on the image reproduction display area 806; an IN point display box 801 for displaying an IN point time code of the editing point; an IN point fixing toggle button 809 capable of setting the IN point of the editing point differently from a preset priority order; an OUT point display box 802 for displaying an OUT point time code of the editing point; an OUT point fixing toggle button 810 capable of setting the OUT point of the editing point differently from the preset priority order; an interval display box 803 for displaying a time interval between the IN and OUT points of the editing points; an interval fixing toggle button 811 capable of setting the interval differently from the preset priority order; an IN point setting button 804; an OUT point setting button 805; and the like.

Similar to conventional techniques, with the first method of determining an editing point of moving images, images reproduced by the video recording/reproducing apparatus 207 and displayed on the image reproduction display area 806 are monitored to search and determine a desired scene (position) to be edited and store the time code of the image of the desired scene. With the second method, a predetermined time code of an editing point of a moving image of a desired scene is entered from the keyboard 205 (while the image corresponding to the entered time code is reproduced in some case), and the entered time code is stored. With the moving image editing method of the invention, the IN and OUT point fixing toggle buttons 809 and 810 and interval fixing toggle button 811 are provided, and by operating upon one of the fixing toggle buttons, it becomes possible to set the item of the change point which is automatically calculated and set again when the value of some item once set is changed.

If all of the IN and OUT point fixing toggle buttons 809 and 810 and interval fixing toggle button 811 are turned off, and when the value of some item once set is changed, one of the other two items is selected in accordance with the priority order and automatically calculated.

If one of the IN and OUT point fixing toggle buttons 809 and 810 and interval fixing toggle button 811 is turned on and another item is changed, the value of the editing point for the turned-on fixing toggle button is maintained unchanged. Only one of the three fixing toggle buttons is allowed to be turned on at a time.

Specifically, for example, if OUT point fixing toggle button 810 is turned on after the IN point fixing toggle button 809 was turned on, the state of the previously turned-on IN point fixing toggle button 809 is changed to the off-state to give a priority to the later turned-on fixing toggle button.

The maximum number of turned-off fixing toggle buttons is “3” and all the fixing toggle buttons can be turned off.

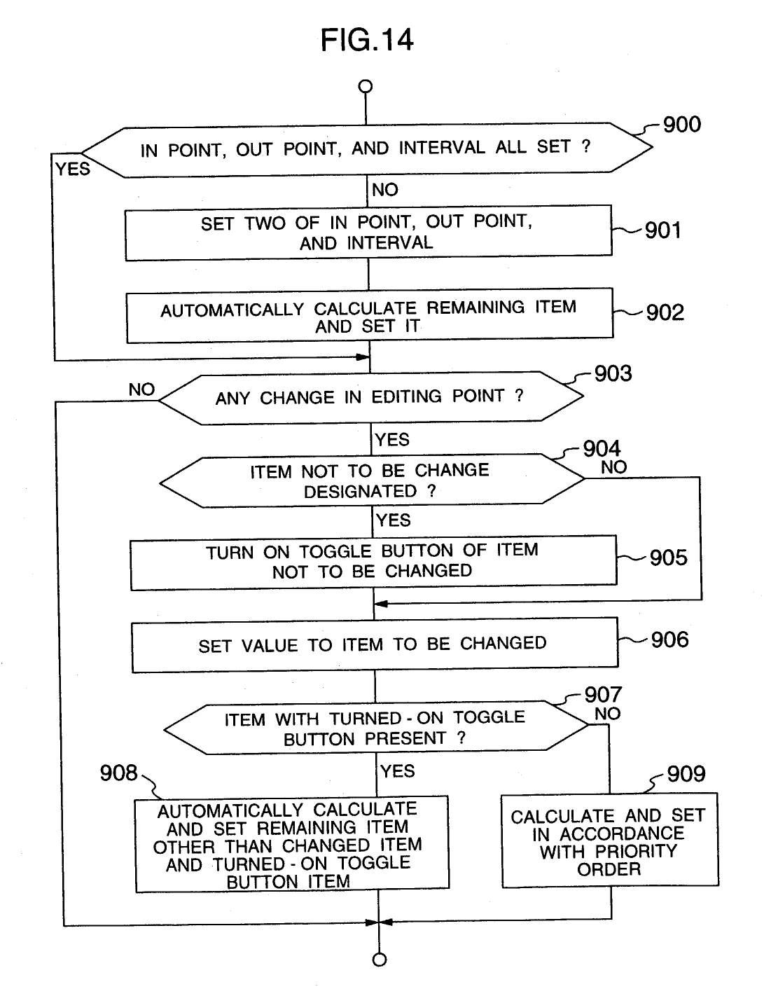

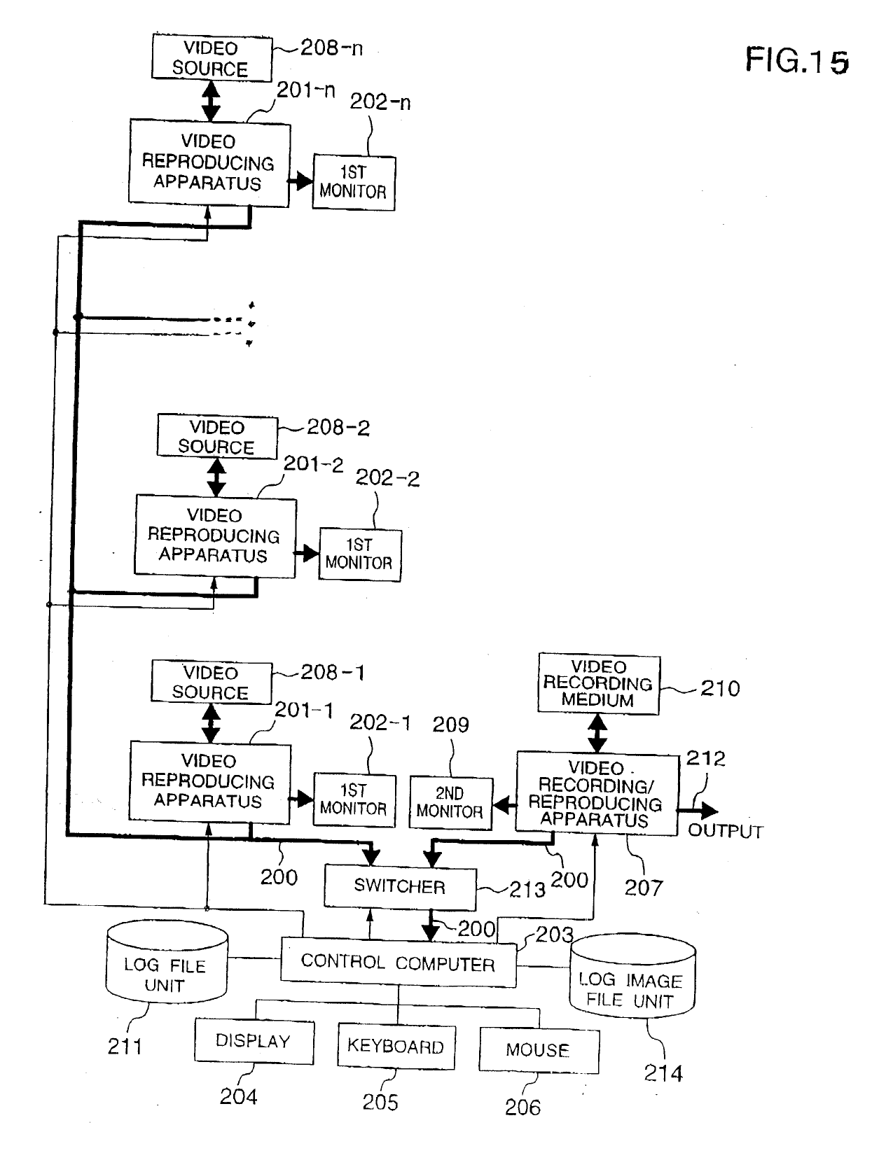

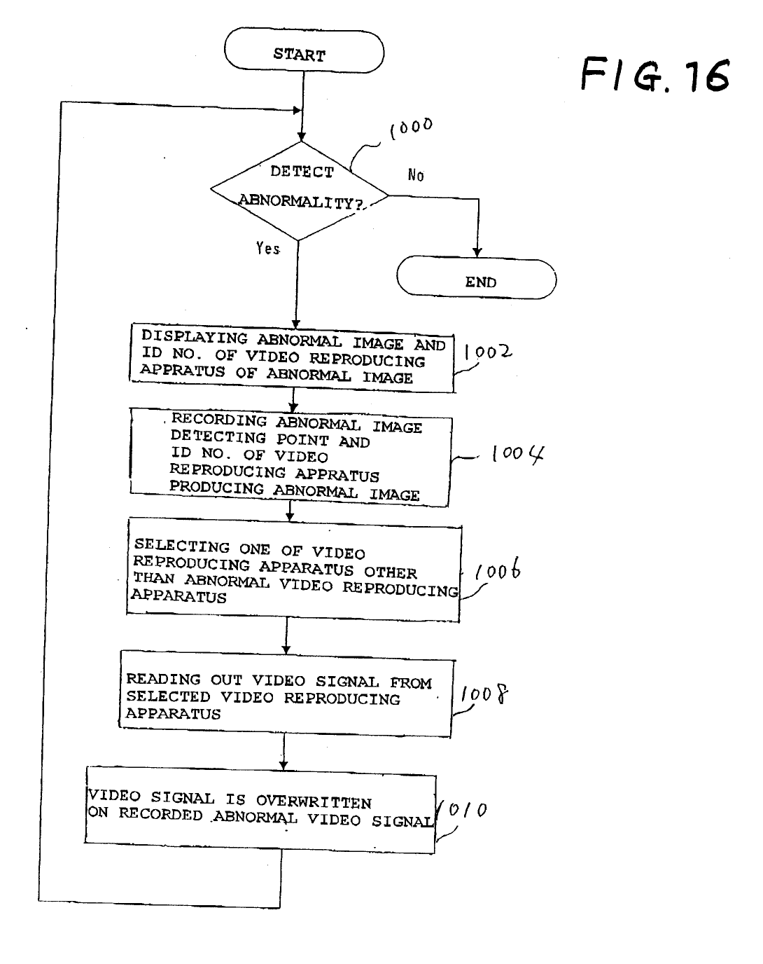

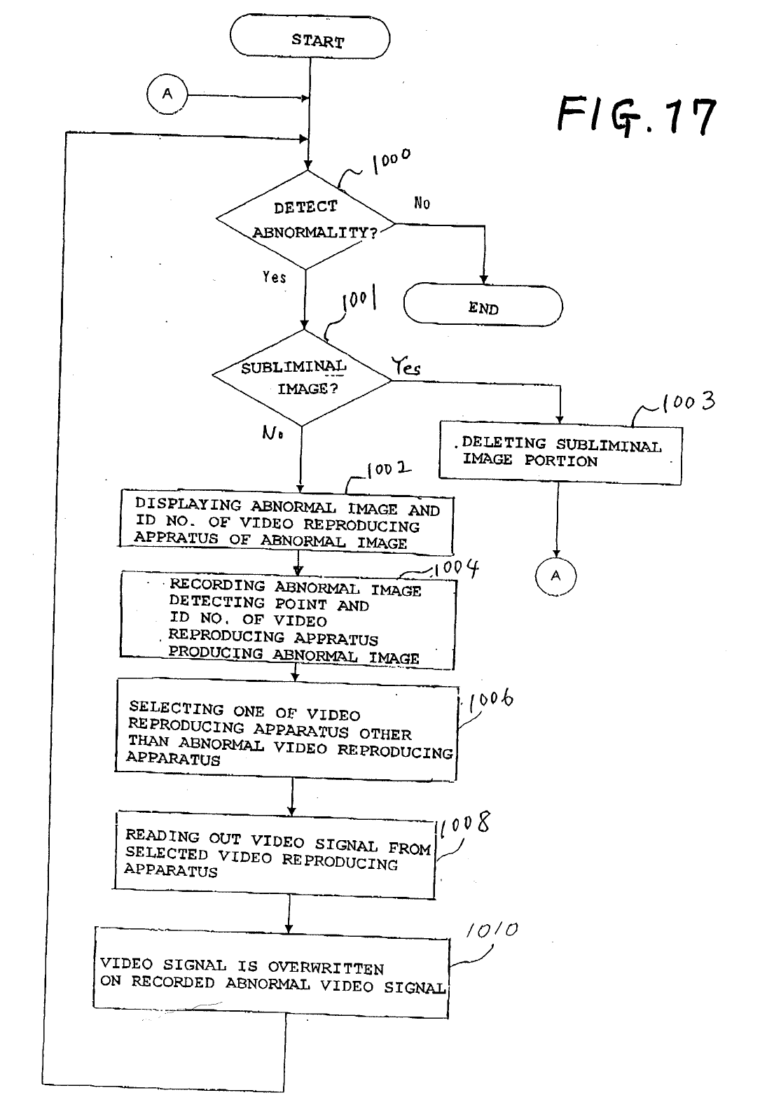

A method of determining an editing point of moving images by using the IN and OUT point fixing toggle buttons 809 and 810 and interval fixing toggle button 811 will be described with reference also to FIG. 14.

In the initial state when determining the editing point of moving images starts, all the IN and OUT point fixing toggle buttons 809 and 810 and interval fixing toggle button 811 are being turned off, and none of the editing points of the three items of the IN and OUT points and interval are not being set (refer Step 900 in FIG. 14).

By using a reproduction button 813 of an operation button group 808 on the operation window 800 of the display 204, a feed fast forward, and a feed backward button to make the video recording/reproducing apparatus 207 enter a reproduction state and display moving images to be edited, on an image reproduction display area 806 of the operation window 800 displayed on the display 204. The reproduced moving images displayed on the image reproduction display area 806 are monitored. When a desired image to be used as a start point (IN point) of the moving image to be edited is reproduced, push a pause button 814 by using the mouse 206, and the mouse 206 is clicked. The reproduction is therefore stopped and the reproduced image displayed on the image reproduction display area 806 enters a pause state.

In this pause state, the pointer is moved to a frame forward reproduction button 815, a frame backward reproduction button 816, or a shuttle function slider 812 by using the mouse 206, and the mouse is clicked to determine a correct position of the IN point through frame advance or the like.

After the position of the IN point is determined, the pointer is placed on an IN point setting button (Mark In) 804 by using the mouse 206, and the mouse 206 is clicked. The time code displayed in the time code display box 807 is therefore set as the IN point, and the time code in the time code display box 807 is copied to and displayed in an IN point display box 801. In this manner, an operation of setting one IN point is completed, and the IN point is stored in a memory of the editing control computer 203 (refer to Step 901 in FIG. 14).

Next, the pointer is again placed on the reproduction button 813 by using the mouse 206, and the mouse 206 is clicked. The video recording/reproducing apparatus 207 is therefore set to the reproduction state so that the reproduced moving image is displayed on the image reproduction display area 806 of the operation window 800 displayed on the computer display 204 to thereafter set the end point (OUT point) of the moving image to be edited.

The reproduced moving images displayed on the image reproduction display area 806 are monitored. When a desired image to be used as the OUT point of the moving image to be edited is reproduced, the pointer is placed on the pause button 814 by using the mouse 206, and the mouse 206 is clicked. The reproduction is therefore stopped and the reproduced image displayed on the image reproduction display area 806 enters the pause state.

In this pause state, the pointer is moved to the frame forward reproduction button 815, frame backward reproduction button 816, or shuttle function slider 812 by using the mouse 206, and the mouse is clicked to determine a correct position of the OUT point through frame advance or the like.

After the position of the OUT point is determined, the pointer is placed on an OUT point setting button (Mark Out) 805 by using the mouse 206, and the mouse 206 is clicked. The time code displayed in the 10 time code display box 807 is therefore set as the OUT point, and the time code in the time code display box 807 is copied to and displayed in an OUT point display box 802. In this manner, an operation of setting one OUT point is completed and the time code is stored in a memory of the editing control computer 203 (refer to Step 901 in FIG. 14).

After the IN point and OUT point are set by the above operations, an interval or a time duration between the IN and OUT points, i.e., a time duration of moving images to be edited, is automatically calculated by the editing control computer 203 and displayed in an interval display box 803. An operation of setting one interval is completed and the interval is stored in a memory of the editing control computer 203 (refer to Step 902 shown in FIG. 14).

By repeating the above editing operation, a desired program can be edited.

Consider for example an editing operation that the IN point is changed (Step 903 in FIG. 14) and the OUT point is maintained unchanged, after the editing points IN, OUT and interval are set by the above editing operation. In this case, push the OUT point fixing toggle button 810 by using the mouse 206 and the mouse is clicked to turn on the OUT point fixing toggle button 810 (refer to Steps 904 and 905 in FIG. 14).

It is assumed here that the IN point value is increased by three frames.

The pointer is placed on the IN point display box 801 and the IN point value larger by three frames is entered from the keyboard 205 (refer to Step 906 in FIG. 14).

The OUT point fixing toggle button 810 is in 15 the on-state and the OUT point value is fixed. Therefore, as the IN point value is increased by three frames, the remaining item or interval is automatically calculated and the value in the interval display box 803 is changed to a value smaller by three frames (refer to Step 908 in FIG. 14).

Next, consider for example an editing operation that the IN point is changed and the interval is maintained unchanged, after the editing points IN, OUT and interval are set. In this case, the pointer is placed on the interval fixing toggle button 811 by using the mouse 206 and the mouse is clicked to turn on the interval fixing toggle button 811 (refer to Steps 904 and 905 in FIG. 14).

It is assumed here that the IN point value is increased by three frames. The pointer is placed on the IN point display box 801 and the IN point value larger by three frames is entered from the keyboard 205 (refer to Step 906 in FIG. 14).

The interval fixing toggle button 811 is in the on-state and the interval value is fixed. Therefore, as the IN point value is increased by three frames, the remaining item or OUT point is automatically calculated 10 and the value in the OUT point display box 802 is changed to a value larger by three frames (refer to Step 908 in FIG. 14).

If an additional editing operation is to be performed after the editing points IN, OUT and interval are set once and any fixing toggle button is not turned or, i.e., all the fixing toggle buttons are maintained tuned on, then the remaining item is automatically selected and calculated in accordance with a predetermined priority order (refer to Step 909 in FIG. 14).

The item with the turned-on fixing toggle button has a fixed set value of the editing point, so that the system is programmed not to allow the keyboard 205 to enter a value.

In this embodiment, an item whose set value of the editing point is not automatically calculated, i.e., an item whose set value of the editing point is maintained unchanged, is selected. In another embodiment contrary with this embodiment, an item whose set value of the editing point is automatically calculated by the editing control computer 203, i.e., an item whose set value of the editing point is changed, may be selected.

In this embodiment method, the editing point of the item with the turned-on fixing toggle button is automatically set. Of the three items of editing points including the IN and OUT points and interval, one of the fixing toggle buttons is made always turned on, and all of the buttons cannot take the off-state at a time.

Similar to the above embodiment, the item of the turned-on fixing toggle button is programmed in this system so as not to enter a new value from the keyboard.

For example, if the OUT fixing toggle button 810 is on, the OUT point of the editing point is automatically set.

With the moving image editing method of this invention, any item among the IN and OUT points and interval can be selected as desired so that the editing point of moving images of the selected item is not set automatically. A problem that the item not desired to be changed is automatically set upon a change in one item, will not occur.

For example, it is possible to select one of the OUT point and interval when the IN point is changed, in accordance with applications and objects of setting editing points. It is not necessary to enter again the value of an item once set, so that the editing point can be set efficiently.

According to the embodiment of the invention, means is provided for instructing to select either the item whose value is automatically set or the item whose set editing point value is maintained unchanged and is not automatically set. By utilizing this means, a moving image editing method can be provided which can efficiently set editing points.

According to the present invention, the operator can check the image quality of the recorded moving images by monitoring the log image window without reproducing whole moving images from the recording medium, and a re-recording of the desired images can be easily and quickly made.

The video system of the invention is applicable not only to the above embodiments, but also to a system which uses a magnetic tape as a recording medium 210 of the video recording/reproducing apparatus 207.

The invention is not limited only to the above embodiments. It is apparent that various modifications and applications may be made by those skilled in the art from the disclosure of this invention.

What is claimed is:

1. An apparatus for correcting an abnormality of video signal of a video system comprising;
a plurality of reproducing devices for reproducing moving images including video frames from a plurality of video recording media, respectively;
a display device for displaying said reproduced moving images;
a first detector for detecting an abnormality state relating to a quality of said moving images reproduced from one of said reproducing devices;
a video storage device for recording moving images as still images in accordance with results of said first detector,
wherein the qualities of at least a part of said moving images being abnormal;
display control means for reading out said still images of the abnormal moving images from said video storage device,
a selector for selecting another reproducing device other than the reproducing device reproducing said abnormal moving images in order to substitute said abnormal moving images with normal moving images; and
a control device for reading out said normal moving images from said another reproducing device and over-writing said abnormal moving images stored in said video storage device with said normal moving images read out from said another reproducing device.

2. An apparatus according to claim 1, further comprising:
a second detector for detecting change points of images from said reproduced moving images; and
means for designating still images representative of a series of frame images constituting moving images from the change point to a next change point,
wherein said still images representative of a series of frame images being recorded into said video storage device, and
wherein said display control means reads out both said representative still images of a series of said frame images and said still images of said abnormal moving images from said video storage device, and displays both said still images on said display device in a manner that said abnormal moving images discriminate from said representative still images of a series of said frame images.

3. An apparatus according to claim 2, further comprising:
means for generating time information relating to said representative still images of a series of said frame images and said still images of said abnormal moving images, wherein said video storage device stores said time information in accordance with said representative still images and the still images of said abnormal moving images.

4. An apparatus according to claim 3, wherein said display control means comprises:
means for displaying the time information in association with said representative still images and said still images of said abnormal moving images on the screen of said display device.

5. An apparatus according to claim 4, wherein said display control means comprises:
means for reproducing moving images from said video storage device in association with said time information and displaying said moving images on said display device.

6. An apparatus according to claim 1, wherein said first detector for detecting said abnormality state comprises:
means for calculating a correlation of image data between a frame to be detected and an adjacent frame thereof and detecting said abnormality state of said moving images in accordance with the calculated correlation.

7. An apparatus according to claim 1, wherein said first detector for detecting said abnormality state comprises:
means for dividing a frame to be detected, into a plurality of regions, calculating a histogram of image data in each region, and detecting said abnormality state of said moving images in accordance with the calculated histogram.

8. An apparatus according to claim 1, wherein said first detector for detecting said abnormality state detects specific signal components relating to image disturbance in said moving images and detects said abnormality state of said moving images in accordance with the detected specific signal component.

9. An apparatus according to claim 1, wherein said first detector for detecting said abnormality state detects an occurrence of said abnormality state when a same image continues for a predetermined period.

10. An apparatus according to claim 1, wherein said video storage device comprises:
first and second storage devices,
wherein original moving images read out from a first storage device being stored into said second storage device, and
wherein said abnormality state of said video system is detected based on qualities of said moving images reproduced from said second storage device.

11. An apparatus according to claim 1, further comprising:
means for setting an IN point representative of an editing start position of said moving images, an OUT point representative of an editing end position, and an interval between said IN point and said OUT point;
means for changing said IN and OUT points and said interval; and
means for displaying said IN and OUT points and said interval on said display device.

12. An apparatus according to claim 1, wherein said abnormality state relating to a quality of said moving images includes at least one of image disturbance by noises, lost colors in image and synchronization fluctuation of the video signal.

13. A method for correcting an abnormality of video signal of a video system, comprising the steps of;
reproducing moving images including video frames from a plurality of video recording media stored in a plurality of reproducing devices, respectively;
displaying said reproduced moving images on a display device;
detecting an abnormality state relating to a quality of said moving images reproduced from one of said reproducing devices by a first detector;
recording moving images in a video storage device as still images in accordance with results of said first detector,
wherein the qualities of at least a part of said moving images being abnormal;
reading out said still images of the abnormal moving images from said video storage device;
selecting another reproducing device other than the reproducing device reproducing said abnormal moving images in order to substitute said abnormal moving images with normal moving images; and
reading out said normal moving images from said another reproducing device and over-writing said abnormal moving images stored in said video storage device with said normal moving images read out from said another reproducing device.

14. A method according to claim 13, further comprising the steps of:
detecting a change point of images from said reproduced moving images; and
designating still images representative of a series of frame images constituting moving images from the change point to a next change point,
wherein said still images representative of a series of frame images being recorded into said video storage device, and
wherein said representative still images are read out from said video storage device, and both said still images are displayed on said display device in a manner that said abnormal moving images discriminate from said representative still images of a series of said frame images.

15. A method according to claim 14, further comprising the step of:
generating time information relating to said representative still images of a series of said frame images and said still images of said abnormal moving images, wherein said storage device stores said time information in accordance with said representative still images and the still images of said abnormal moving images.

16. A method according to claim 15, wherein the time information in association with said representative still images and said still images of said abnormal moving images are displayed on the screen of said display device.

17. A method according to claim 16, further comprising the steps of:
reproducing moving images from said video storage device and displaying said moving images on said display device in accordance with said time information.

18. A method according to claim 13, wherein said step of detecting the abnormality state comprises the steps of:
calculating a correlation of images data between a frame to be detected and an adjacent frame thereof; and
detecting said abnormality state of said moving images in accordance with the calculated correlation.

19. A method according to claim 13, wherein said step of detecting the abnormality state comprises the steps of:
dividing a frame to be detected, into a plurality of regions, calculating a histogram of image data in each region; and
detecting said abnormality state of said moving images in accordance with the calculated histogram.

20. A method according to claim 13, wherein said step of detecting the abnormality state comprises the step of:
detecting specific signal components relating to image disturbance in said moving images.

21. A method according to claim 13, further comprising the steps of:
reading out original moving images from a first storage device storing the original moving images; and
recording said original moving images in a second storage device,
wherein said step of detecting the abnormality state detects the abnormality state in accordance with the moving images reproduced from said second storage device.

22. A method according to claim 13, further comprising the steps of:
setting an IN point representative of an editing start position of said moving images, an OUT point representative of an editing end position, and an interval between said IN and OUT points;
changing said IN and OUT points and said interval; and
displaying said IN and OUT points and said interval on said display device.

23. A method according to claim 20, wherein said image disturbance is one of noises, lost colors in image and synchronization fluctuation of the video signal.

24. A computer program product including a computer usable medium having embodied thereon a computer program method for correcting an abnormality of a video signal of a video system, said computer program when executed causes a computer to perform the steps of:
reproducing moving images including video frames from a plurality of video recording media stored in a plurality of reproducing devices, respectively;
displaying said reproduced moving images on a display device;
detecting an abnormality state relating to a quality of said moving images reproduced from one of said reproducing devices by a first detector;
recording moving images in a video storage device as still images in accordance with results of said first detector,
wherein the qualities of at least a part of said moving images being abnormal;
reading out said still images of the abnormal moving images from said video storage device;
selecting another reproducing device other than the reproducing device reproducing said abnormal moving images in order to substitute said abnormal moving images with normal moving images; and
reading out said normal moving images from said another reproducing device and over-writing said abnormal moving images stored in said video storage device with said normal moving images read out from said another reproducing device.

25. A computer program product according to claim 24, wherein said computer program when executed further causes a computer to perform the steps of;
detecting a change point of images from said reproduced moving images; and
designating still images representative of a series of frame images constituting moving images from the change point to a next change point,
wherein said still images representative of a series of frame images being recorded into said video storage device, and
wherein said representative still images are read out from said video storage device, and both said still images are displayed on said display device in a manner that said abnormal moving images discriminate from said representative still images of a series of said frame images.

26. A computer program product according to claim 24, wherein said abnormality state relating to a quality of said moving images includes at least one of image disturbance by noises, lost colors in image and synchronization fluctuation of the video signal.
